(19) United States
(12) Patent Application Publication
(10) Pub. No.: US 2005/0198616 A1
(43) Pub. Date: Sep. 8, 2005

(54) Pattern system generation apparatus and pattern application apparatus

(75) Inventors: Tadahiro Uehara, Kawasaki (JP); Tomotaka Matsuda, Kawasaki (JP); Junji Inomata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/016,756

(22) Filed: Dec. 21, 2004

(30) Foreign Application Priority Data
Mar. 8, 2004 (JP) 2004-064669

(51) Int. Cl. G06F 9/44

(52) U.S. Cl. 717/108; 717/114; 717/120

(57) ABSTRACT

A pattern system generation apparatus of the present invention includes a pattern information storage unit for storing plural patterns usable for object-oriented software development, a pattern system definition unit capable of defining an order relation between two of the plural patterns, an inter-pattern association information storage unit for storing the order relation define for two of the plural patterns, and an inter-pattern conflict detection unit for detecting conflicting elements in the defined order relation; and a pattern application apparatus of the present invention includes the pattern information storage unit, the inter-pattern association information storage unit, a pattern application unit for detailing a model to be developed by applying a pattern stored in the pattern information storage unit to the model, and a pattern system navigation unit capable of activating the pattern application unit by specifying the model to be developed and a pattern.

### BACKGROUND OF THE INVENTION

1. Field of the Invention

The present invention relates to a pattern system generation apparatus and a pattern application apparatus.

2. Description of the Related Art

Object-oriented software technology is for developing software in units of real things (objects). In recent years, many object-oriented analysis and design methods have been proposed.

In object-oriented analysis and design, a specification to be described to make analysis and design is prepared using a prescribed procedure. In preparing such a specification, a software analysis and design support apparatus designed to support generation of a specification is also used.

There are software analysis and design support apparatuses which utilize, for the sake of making a good design, design patterns generated by collecting know-how used in past designs and arranging the collection into a reusable form. Such patterns also facilitate sharing the design know-how within a development project.

Among such patterns are analysis patterns for application to analysis models, design patterns describing structures of plural objects configured to solve a problem in designing, for example, describing a group of classes and their behavior, and implementation patterns providing know-how for source coding required in software implementation. Utilizing patterns in developing a software model and a program improves software productivity.

The non-patent document 1 (see the list below) and other books on such analysis patterns and design patterns have been published in recent years. In such books, concrete models to be developed are described independently of analysis patterns and design patterns. Such books do not go further than generating a specification discretely using analysis patterns and design patterns. A problem with such books is that it is very difficult to understand a variety of existing patterns introduced in the books, select suitable patterns for a model to be developed, determine how to individually apply the selected patterns to the application to be developed and carry out the pattern application. There is also another problem. That is, even when one can understand the patterns introduced in the books, it is only a small portion of the patterns that can be actually applied to the application to be developed.

Among the conventional pattern application support apparatuses are an apparatus to generate a specification by applying patterns as disclosed in the non-patent document 1 (see the list below) and an apparatus for checking whether or not patterns are correctly applied to a model. Both apparatuses, however, require the correspondence between the components of each pattern and the components of a model designed by a developer to be specified by a user when applying the pattern. Therefore, the apparatuses cannot greatly improve pattern application operation.

An apparatus which eliminates the problems as described above has been disclosed in the patent document 3 (see the list below) authored by the present applicant.

The apparatus disclosed in the patent document 3 includes a means for defining and storing patterns, a means for defining and storing relationships between patterns, a means for making an object-oriented software developer navigate to patterns to use based on the relationships, and a means for automating the detailing of a model to be developed and automatically generating a corresponding source code.

In the apparatus, the information defining a relationship between patterns includes the following three definitions: a viewpoint on software development to be considered after applying a pattern, options corresponding to the viewpoint and the pattern to be applied next depending on the selected option. For other constraints in pattern application, descriptions in natural language provided in pattern describing documents are referred to.

The apparatus disclosed in the patent document 3, however, poses the following problems.

Firstly, the relationship between patterns has to be defined carefully by a developer who generates a system of patterns. The developer, for example, has to be sure that an element of a model specified in a pattern is not given a different characteristic when specified in another pattern to be applied next.

Secondly, when no software development viewpoint is provided in the course of applying plural patterns through navigation, it is efficient to detail a model to be developed by a single pattern application. No pattern combining method to be used in such a case is mentioned in the patent document 3.

Thirdly, whereas navigation can be used as a guide for pattern application, the timing of pattern application and preconditions for pattern application are described in natural language, posing a possibility of causing a developer to make an erroneous pattern application due to insufficient understanding of the information provided in the document.

[Non-patent document 1] ‘DESIGN PATTERN FOR REUSE IN OBJECT-ORIENTED CONCEPT’ by E. Gamma, et al. published by SoftBank

[Patent document 1] Japanese Patent Laid-Open No. 9-237180 ‘SOFTWARE DESIGN SUPPORT APPARATUS AND SOFTWARE DESIGN METHOD’

[Patent document 2] Japanese Patent Laid-Open No. 9-198242 ‘OBJECT ORIENTED DESIGN SUPPORT APPARATUS’

[Patent document 3] Japanese Patent Laid-Open No. 2000-305766 ‘OBJECT ORIENTED SOFTWARE DEVELOPMENT SUPPORT APPARATUS AND DEVELOPMENT SUPPORT METHOD’

### SUMMARY OF THE INVENTION

The first object of the present invention is to provide a pattern system generation apparatus capable of efficiently defining and creating a pattern system.

The second object of the present invention is to provide a pattern application apparatus capable of efficient pattern application.

The third object of the present invention is to provide a pattern application apparatus capable of avoiding errors in pattern application.

According to one aspect of the present invention, the pattern system generation apparatus includes a pattern information storage unit for storing plural patterns usable for object-oriented software development, a pattern system definition unit capable of defining an order relation between two of the plural patterns, an inter-pattern association information storage unit for storing the order relation define for two of the plural patterns, and an inter-pattern conflict detection unit for detecting conflicting elements in the defined order relation.

According to another aspect of the present invention, the pattern application apparatus includes the pattern information storage unit, the inter-pattern association information storage unit, a pattern application unit for detailing a model to be developed by applying a pattern stored in the pattern information storage unit to the model, and a pattern system navigation unit capable of activating the pattern application unit by specifying the model to be developed and a pattern.

Other and further objects, features and advantages of the invention will appear more fully from the following description.

### BRIEF DESCRIPTION OF THE DRAWINGS

FIG. 1 is a block diagram showing a configuration of a pattern system generation apparatus according to a first aspect of the present invention;

FIG. 2 is a block diagram showing a configuration of a pattern application apparatus according to a second aspect of the present invention;

FIG. 3 is a block diagram showing a configuration of a modified example of the pattern application apparatus according to the second aspect of the present invention;

FIG. 4 is a diagram showing a configuration of an object-oriented software development support apparatus according to one embodiment of the present invention;

FIG. 5 is a diagram showing an example of pattern defined via a pattern definition unit;

FIG. 6 is a diagram showing an example (1) of pattern system defined via a pattern system definition unit;

FIG. 7 is a flowchart showing operation of a pattern system generation apparatus;

FIG. 8 is a diagram showing an example of precondition for pattern application;

FIG. 9 is a diagram showing an example of pattern combination which develops a conflict just by having an order relation defined;

FIG. 10 is a diagram for explaining processing of an example of pattern combination leading from defining an order relation to merging the patterns;

FIG. 11 is a diagram showing an example (2) of pattern system defined via a pattern system definition unit;

FIG. 12 is a diagram for explaining more concretely one of the inter-pattern order relations defined in FIG. 11;

FIG. 13 is a diagram for explaining merging of the patterns 1 and 2 shown in FIG. 12;

FIG. 14 is a flowchart showing processing to be performed when applying a pattern to a model to which another pattern has been applied;

FIG. 15 is a diagram for explaining a case in which a first pattern is applied to a model to be developed;

FIG. 16 is a diagram for explaining a case in which a second pattern is applied to a model to be developed to which the first pattern shown in FIG. 15 has been applied;

FIG. 17 is a diagram for explaining a case in which a pattern is applied to another model to be developed;

FIG. 18 is a diagram for explaining a case in which a second pattern different from the second pattern shown in FIG. 16 is applied to a model to be developed to which the first pattern shown in FIG. 15 has been applied;

FIG. 19 is a diagram for explaining a case in which an error in pattern application is avoided using a precondition for pattern application;

FIG. 20 is a diagram (1) for explaining work distribution to developers in using an object-oriented software development support apparatus according to the present invention;

FIG. 21 is a diagram (2) for explaining work distribution to developers in using an object-oriented software development support apparatus according to the present invention; and

FIG. 22 is a diagram for explaining loading of a program.

### DESCRIPTION OF THE PREFERRED EMBODIMENTS

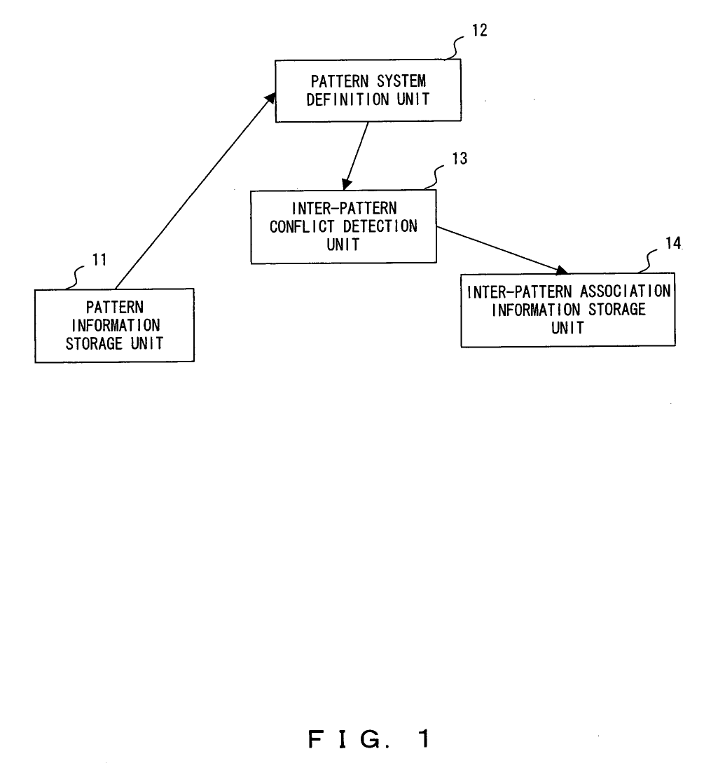

The pattern system generation apparatus according to a first aspect of the present invention is, as shown in FIG. 1, includes a pattern information storage unit 11 for storing plural patterns usable for object-oriented software development, a pattern system definition unit 12 capable of defining an order relation between two of the plural patterns, an inter-pattern association information storage unit 14 for storing an order relation defined for two of the plural patterns, and an inter-pattern conflict detection unit 13 for detecting conflicting elements in the defined order relation. And the pattern-system definition unit 12 is capable of activating the inter-pattern conflict detection unit 13.

When two of the plural patterns are specified, conflicting parts, if any, between the two patterns are indicated by the inter-pattern conflict detection unit 13 so that a pattern developer can proceed efficiently with defining a pattern system without being bothered to check for conflicts between the two patterns himself or herself.

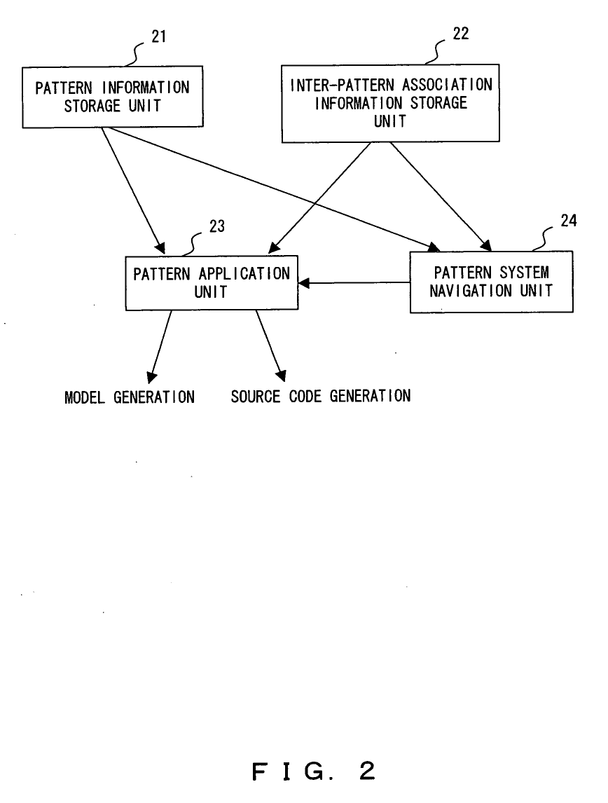

The pattern application apparatus according to a second aspect of the present invention includes, as shown in FIG. 2, a pattern information storage unit 21 for storing plural patterns usable for object-oriented software development, an inter-pattern association information storage unit 22 capable of storing plural order relations, each defined for two of the plural patterns, and conflict resolution information specified for resolvable conflicting elements in the order relations, maintaining correspondence between the conflict resolution information and the order relations, a pattern application unit 23 for detailing a model to be developed by applying a pattern stored in the pattern information storage unit to the model, and a pattern system navigation unit 24 capable of activating the pattern application unit 23 by specifying a model to be developed and a pattern.

In the second aspect, an arrangement may be made such that, in applying two patterns to the model to be developed, if conflict resolution information corresponding to the two patterns exists, the pattern application unit 23 reflects the conflict resolution information in the pattern application processing.

With the above arrangement made, when the corresponding conflict resolution information is determined to exist, it is reflected in the pattern application processing so that the software developer can efficiently proceed with applying the patterns without being bothered to resolve the conflict himself or herself.

In the second aspect, arrangements may be made such that the pattern information storage unit 21 stores pattern information obtained by merging two patterns for which an order relation has been defined maintaining correspondence between the pattern information and the order relation, and the pattern application unit 23, when applying two patterns to a model to be developed, checks to see whether or not a merged pattern corresponding to the two patterns exists in the pattern information storage unit 21, and if such a merged pattern exists, the pattern application unit 23 applies the merged pattern to the model to be developed.

With the above arrangements made, when a merged pattern corresponding to the two patterns to be applied is determined to exist in the pattern information storage unit 21, the merged pattern is applied to the model to be developed so that the pattern application is carried out efficiently without bothering a software developer to correct a relevant portion of source code himself or herself.

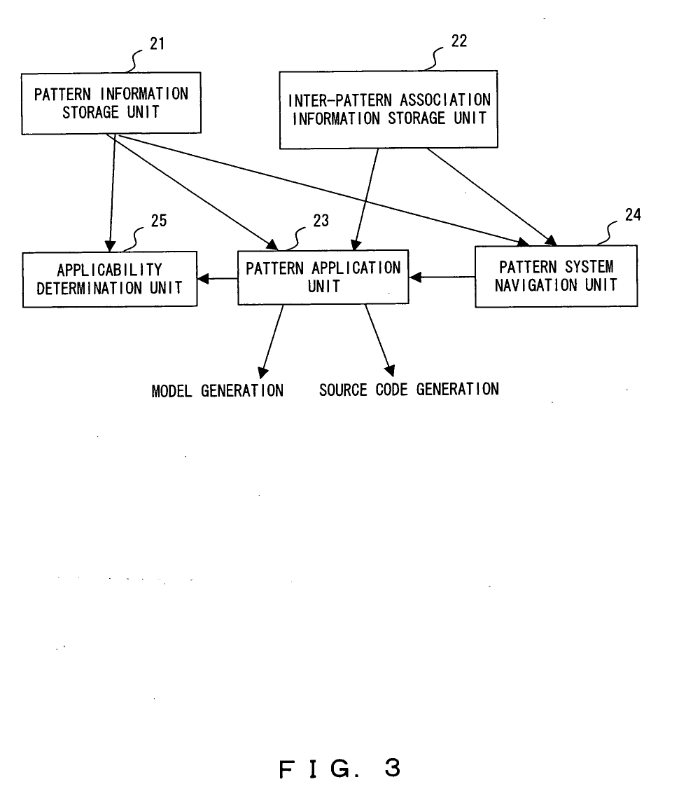

In the second aspect, as shown in FIG. 3, arrangements may be made such that the pattern information storage unit 21 also stores preconditions for pattern application, i.e., preconditions to be met before a pattern is applied maintaining correspondence between the preconditions for pattern application and the pattern and the pattern application apparatus further includes an applicability determination unit 25 which, when applying the pattern to the model to be developed, determines based on the preconditions for pattern application whether or not the pattern is applicable.

When the above arrangements are made, the pattern applicability is determined by the applicability determination unit 25 so that a software developer is prevented from making erroneous pattern application resulting from his or her failure to read or correctly understand a relevant document and observe a precondition or an application method.

In the pattern system generation apparatus of the present invention, conflicting parts between two of the plural patterns are indicated by the inter-pattern conflict detection unit so that a pattern developer can proceed efficiently with defining a pattern system without being bothered to check for conflicting parts himself or herself.

The pattern application apparatus of the present invention, when conflict resolution information is determined to exist, reflects the conflict resolution information in pattern application to a model so that a software developer can proceed efficiently with pattern application without being bothered to resolve conflicts between patterns himself or herself.

Also, the pattern application apparatus of the present invention, when a merged pattern corresponding to two patterns to be applied is determined to exist in the pattern information storage unit 21, applies the merged pattern to the model to be developed so that a software developer can proceed efficiently with pattern application without being bothered to correct a relevant portion of source code himself or herself.

In the pattern application apparatus of the present invention, pattern applicability is determined by the applicability determination unit so that a software developer is prevented from making erroneous pattern application resulting from his or her failure to read or correctly understand a relevant document and observe a precondition or a prescribed application method.

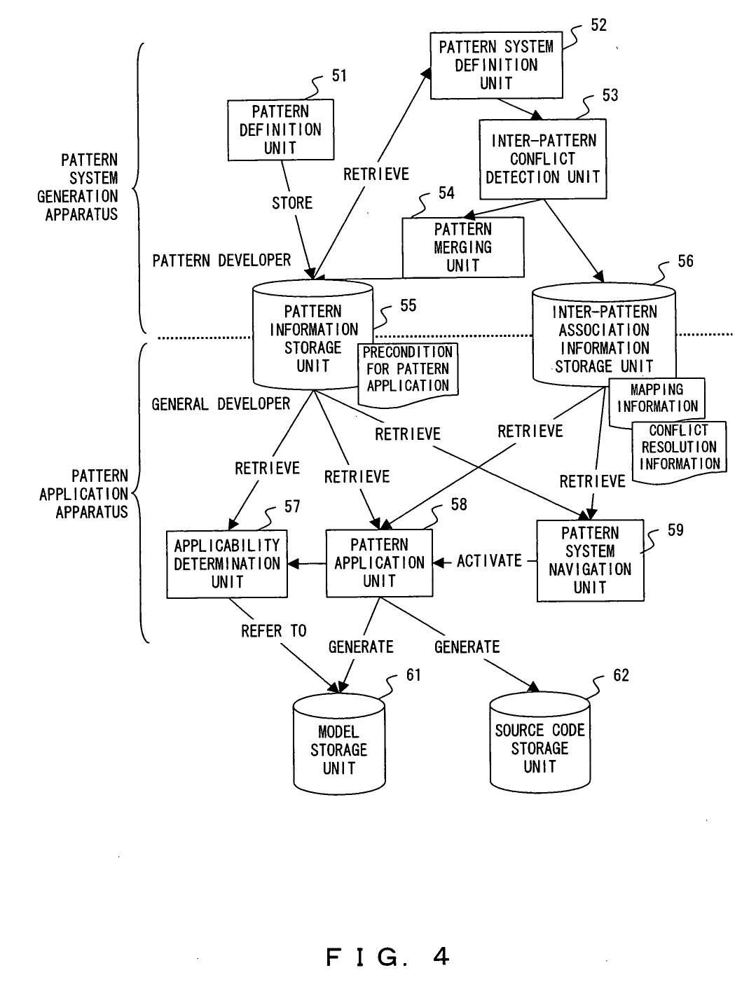

FIG. 4 is a diagram showing a configuration of an object-oriented software development support apparatus of the present invention. As shown in FIG. 4, an object-oriented software development support apparatus 50 includes a pattern system generation apparatus and a pattern application apparatus for using the pattern system.

In FIG. 4, the portion above the broken line in the center corresponds to the pattern system generation apparatus and the portion below the broken line corresponds to the pattern application apparatus.

First, the pattern system generation apparatus will be described.

The pattern system generation apparatus includes a pattern definition unit 51, a pattern system definition unit 52, an inter-pattern conflict detection unit 53, a pattern merging unit 54, a pattern information storage unit 55, and an inter-pattern association information storage unit 56. The pattern system generation apparatus is for use by a pattern developer to develop patterns.

The pattern definition unit 51 is an editor used by a pattern developer when defining a pattern. When a pattern is defined, the pattern is stored in the pattern information storage unit 55. The pattern system definition unit 52 is an editor used by a developer when creating a pattern system based on the patterns stored in the pattern information storage unit 55. A pattern system is composed of plural order relations, each defined for two patterns. Such defined order relations are stored in the inter-pattern association information storage unit 56.

The inter-pattern conflict detection unit 53 is activated by an instruction issued by a pattern developer from the pattern system definition unit 52. The inter-pattern conflict detection unit 53 includes processing to detect conflicting elements between patterns which are hierarchically positioned (with order relations defined) and which belong to a same category (i.e., between analysis patterns or between design patters) in a pattern system, processing to indicate the detected conflicting elements, and processing to store conflict resolution information inputted by a pattern developer for resolvable ones of the detected conflicting elements in the inter-pattern association information storage unit 56 maintaining correspondence between the conflict resolution information and the inter-pattern order relations.

The pattern merging unit 54 is activated by an instruction issued by a pattern developer from the inter-pattern conflict detection unit 53 and performs processing to merge two patterns for which at least an order relation has been defined. The merge processing results in generating part of the final result of merging the two patterns. The remaining part of the final result of merging the two patterns includes, for example, correction to be made, after resolving a conflict between the two patterns, on the relevant portion of the source code model corresponding to the lower-order pattern. Such correction is made by a pattern developer via the pattern merging unit 54.

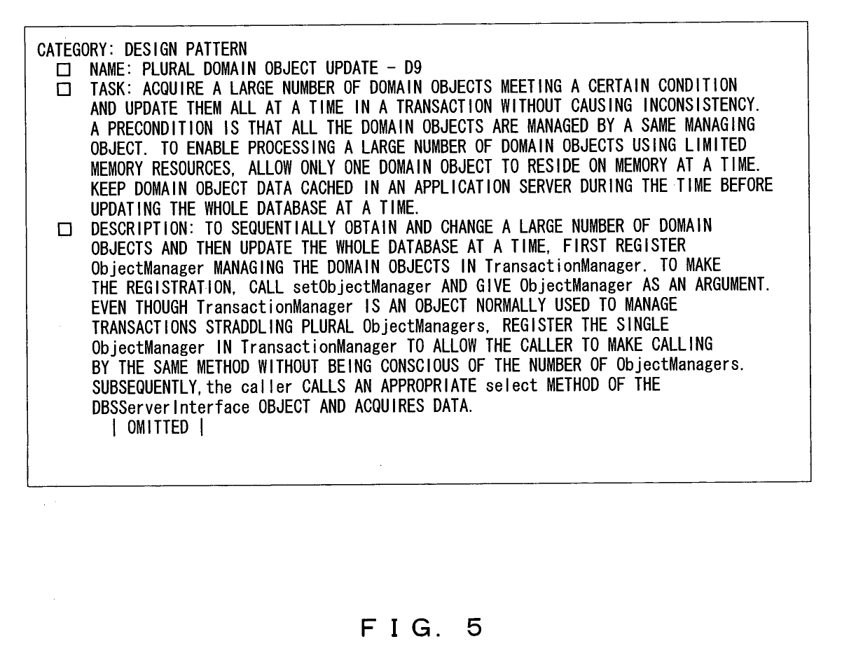

FIG. 5 is a diagram showing an example of pattern defined via the pattern definition unit.

As shown in FIG. 5, a pattern includes such items as category, name, viewpoint and description.

The category indicates whether the pattern is an analysis pattern, a design pattern or an implementation pattern.

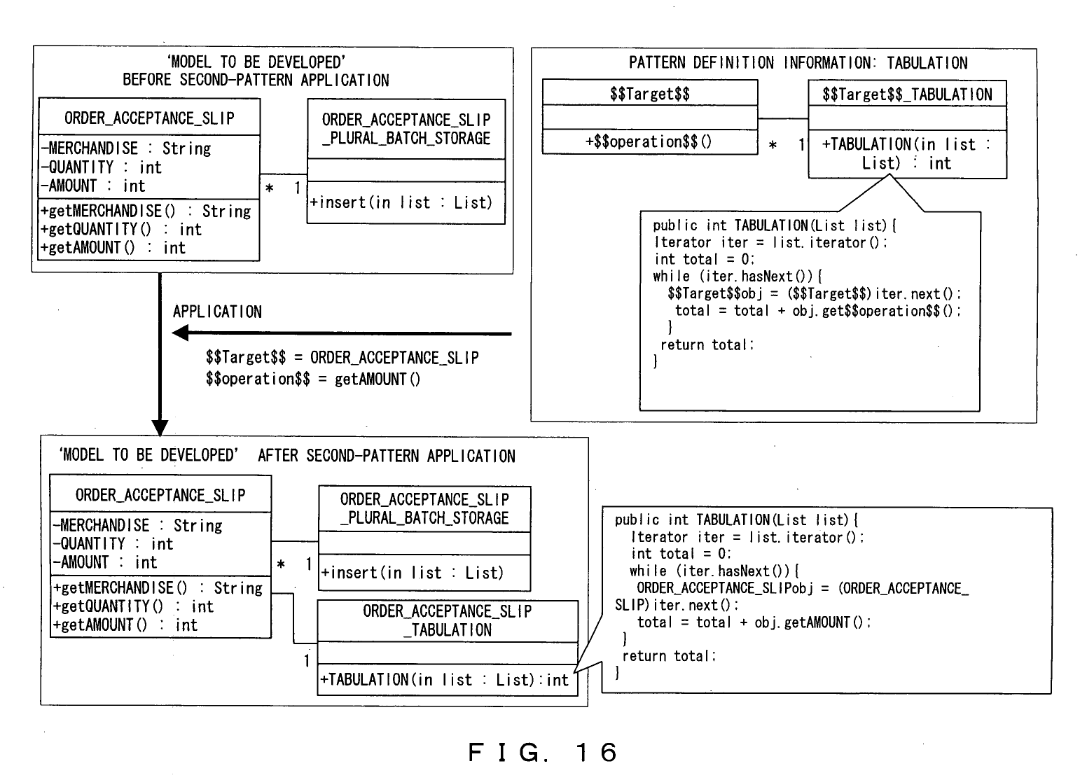

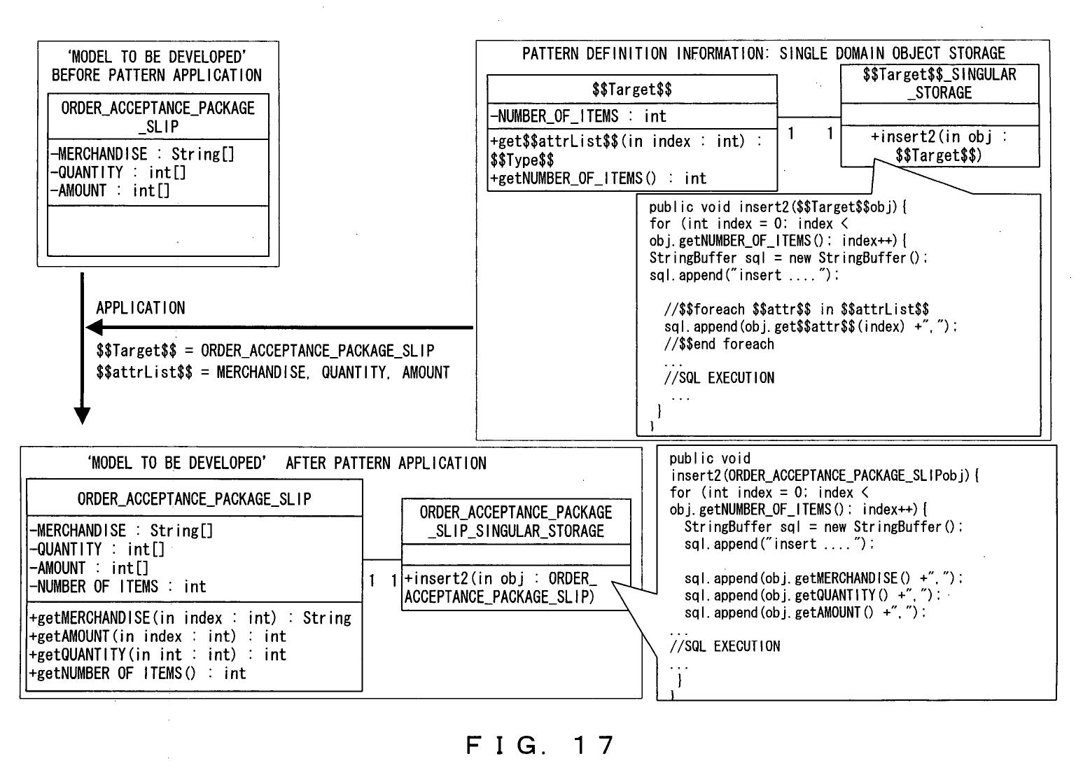

The viewpoint and the description are documents written in natural language. They are referred to by a pattern developer or a general developer, being described later, as required. Though not shown in FIG. 5, the pattern information also includes an item “definition”. The definition includes pattern definition information examples of which are shown in FIGS. 16 and 17.

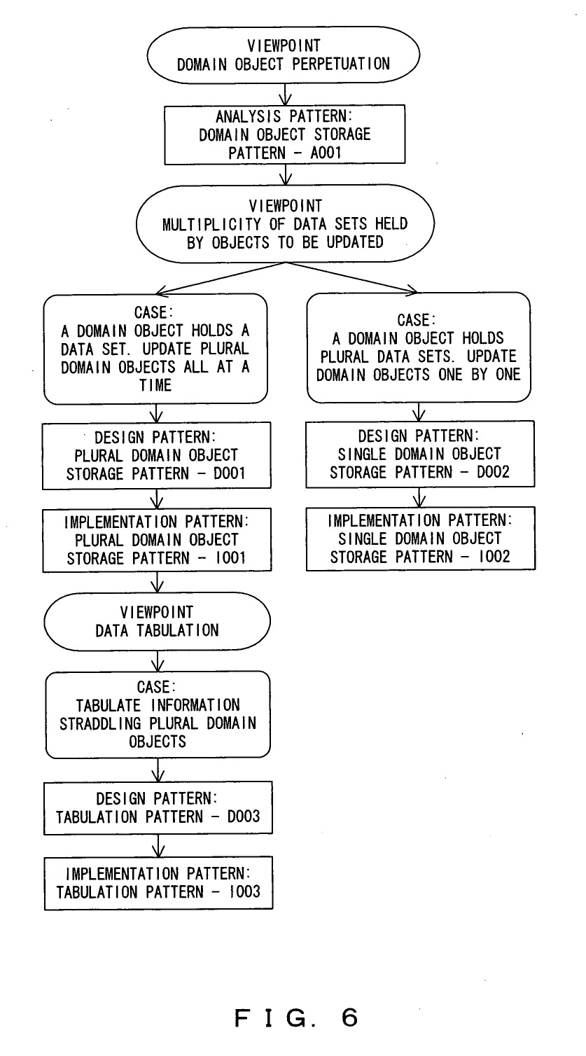

FIG. 6 is a diagram showing an example (1) of pattern system defined via the pattern system definition unit.

The pattern system shown in FIG. 6 hierarchically shows an analysis pattern in a high-order position, design patterns and implementation patterns in low-order positions. More concretely, the pattern system is composed of three principal parts, that is, a viewpoint on software development to be considered after applying a pattern, options (cases) corresponding to the viewpoint and the patterns to be applied next depending on the selected option.

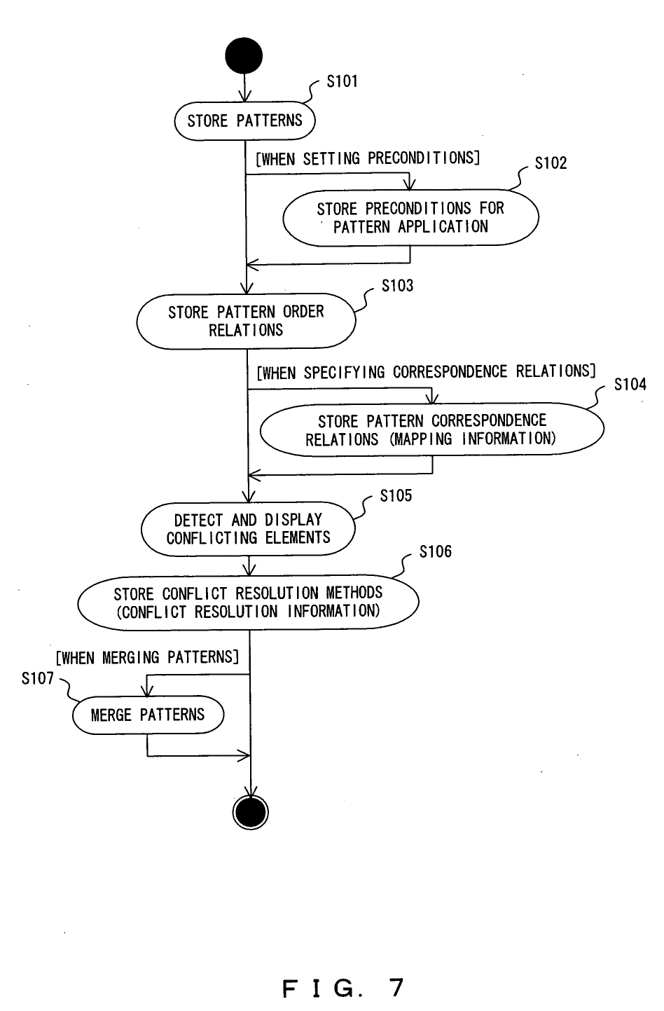

FIG. 7 is a flowchart showing operation of the pattern system generation apparatus.

In the flow of operation shown in FIG. 7, first the pattern information definition unit is activated by a pattern developer and pattern information is inputted. Then, in step S101, the pattern information defined by the pattern developer is stored in the pattern information storage unit. For the pattern thus defined (stored), a precondition for pattern application can be selectively set. When a precondition for pattern application is set, it is stored, being associated with the corresponding pattern information, in the pattern information storage unit in step S102.

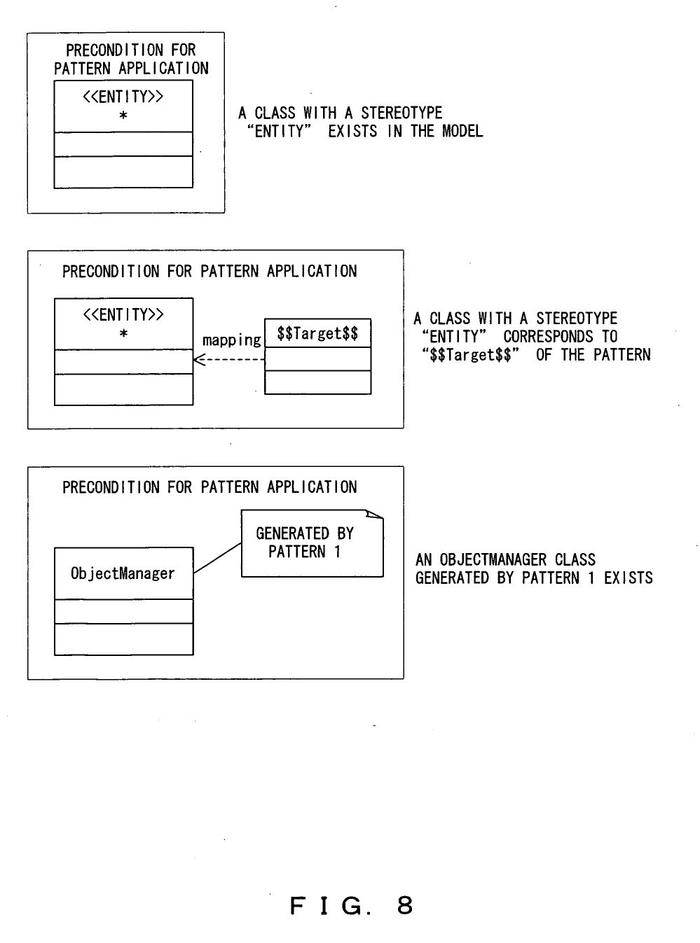

A precondition for pattern application may be information, for example as shown in FIG. 8, “A class with a stereotype ‘entity’ must exist in the model” or “A class with a stereotype ‘entity’ corresponds to $$Target$$ of the pattern” or “An ObjectManager class generated by pattern 1 must exist.” Namely, a precondition for pattern application is information specifying a type, structure or characteristic of a model element required to exist on the model to be developed. In the above, the stereotype is an identifier used in classifying classes (models) and the entity indicates that the class (model) associated with it has an attribute requiring the class (model) to be stored, for example, in a database.

Next, regardless of whether a precondition for pattern application is set or not, the pattern system definition unit is activated by the pattern developer. The pattern developer then specifies two patterns and an order relation between the two patterns is defined. Subsequently, the defined order relation is stored in the inter-pattern association storage unit in step S103.

For the order relation thus defined, a pattern correspondence relation (mapping information) can be selectively set. In that case, in step S104, the pattern correspondence relation is associated with the corresponding order relation and stored in the inter-pattern association information storage unit. The mapping information mentioned above indicates with which elements of the pattern to be applied first the parameters of the pattern to be applied next are to be associated.

In the next step S105, conflicting elements are detected by taking into account the order relation stored in step S103 and, in a case in which step S104 has been performed, also the pattern correspondence relation stored in step S104, and conflicting elements if detected are displayed.

In this detection/display processing, if an order relation between, for example, the patterns 1 and 2 has been defined, whether or not the pattern 2 has any model element identical with a model element (class, method, attribute, or association) of the pattern 1 is checked on the basis of names (signature in the case of a method or role names at both ends in the case of an association). If such a model element is found to exist in the pattern 2, whether or not the properties (for example, type and initial value in the case of attributes, and visibility and return type in the case of methods) of the two model elements coincide is checked. If they do not coincide, the model elements are displayed as conflicting elements.

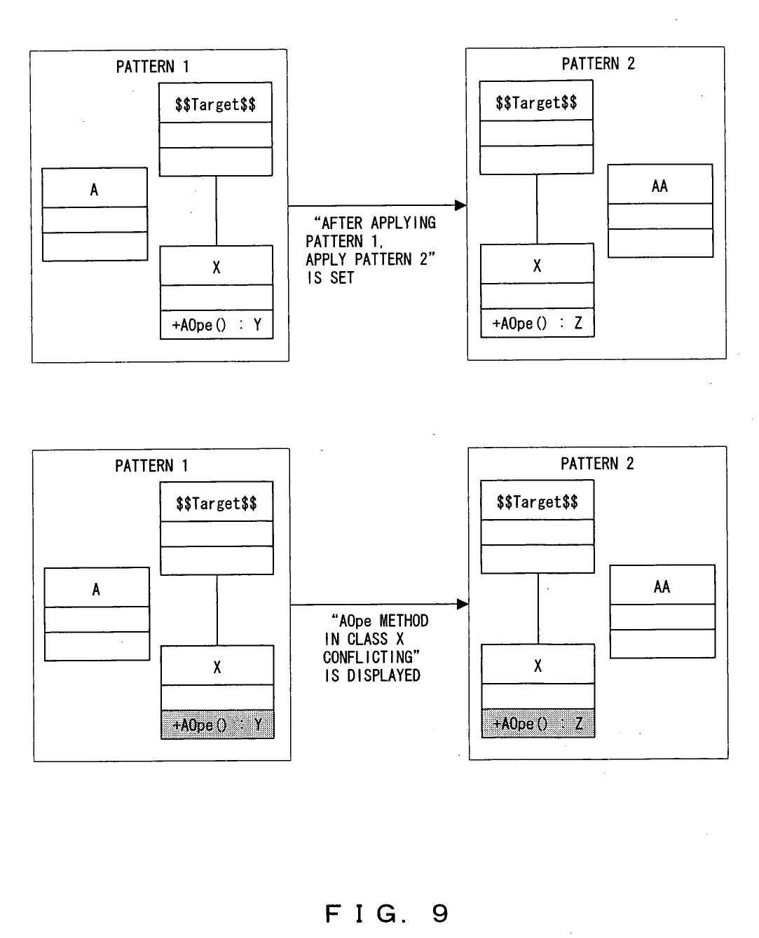

FIG. 9 is a diagram showing an example of pattern combination which develops a conflict just by having an order relation defined. The upper half portion of FIG. 9 shows a process, corresponding to step S103, in which an order relation “After applying pattern 1, apply pattern 2” is defined.

The patterns 1 and 2 shown in FIG. 9 both specify “Add class X”. However, whereas the method “+AOpe( ):Y” of class X in the pattern 1 and the method “+AOpe( ):Z” of class X in the pattern 2 have the same signature, they have different return types Y and Z. In this case, as shown in the lower half of FIG. 9, the corresponding model elements are highlighted on the display and a message to the effect that a conflict exists in the class X AOpe method appears.

When the conflict in the conflicting elements detected in step S105 is resolvable, the pattern developer sets a resolution method as conflict resolution information. The conflict resolution method thus set is stored, being associated with the corresponding order relation, in the inter-pattern association storage unit in step S106.

There can be cases in which the conflict in the conflicting elements detected in step S105 is not resolvable. An arrangement may be made so that, in such cases, a message urging, if mapping information exists, the pattern developer to change the mapping information or, if mapping information does not exist, notifying the pattern developer that the particular order relation cannot be specified is displayed on the screen.

When the conflict is resolvable, an option is available to merge, in step S107, the patterns for which an order relation has been defined in step S103 into one pattern.

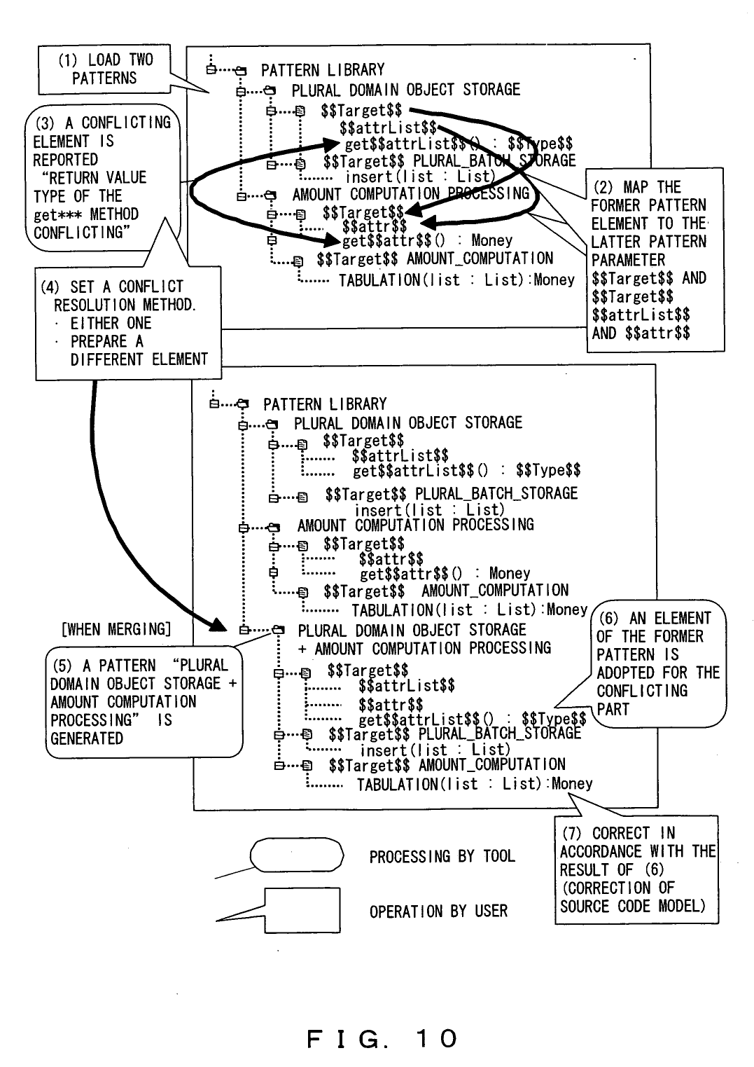

FIG. 10 is a diagram for explaining processing of an example of pattern combination leading from defining an order relation to merging the patterns.

In the flow of operation shown in FIG. 10, first, two patterns are loaded according to an instruction from a pattern developer and then an order relation between the two patterns is defined. Namely, it is defined by the pattern developer that after applying the “plural domain object storage” pattern (hereinafter referred to as the “former pattern”), the “amount computation processing” pattern (hereinafter referred to as “the latter pattern”) is applied. Following the definition of the order relation, mapping information is specified. In this case, the mapping information is composed of mapping the $$Target$$ of the latter pattern to the $$Target$$ of the former pattern and mapping the $$attrlist$$ of the latter pattern to the $$attr$$ of the former pattern. Based on the order relation and mapping information, the inter-pattern conflict detection unit performs processing to detect and display conflicts. As a result of the processing, a message, for example, “the return type of the get*** method conflicting” is displayed.

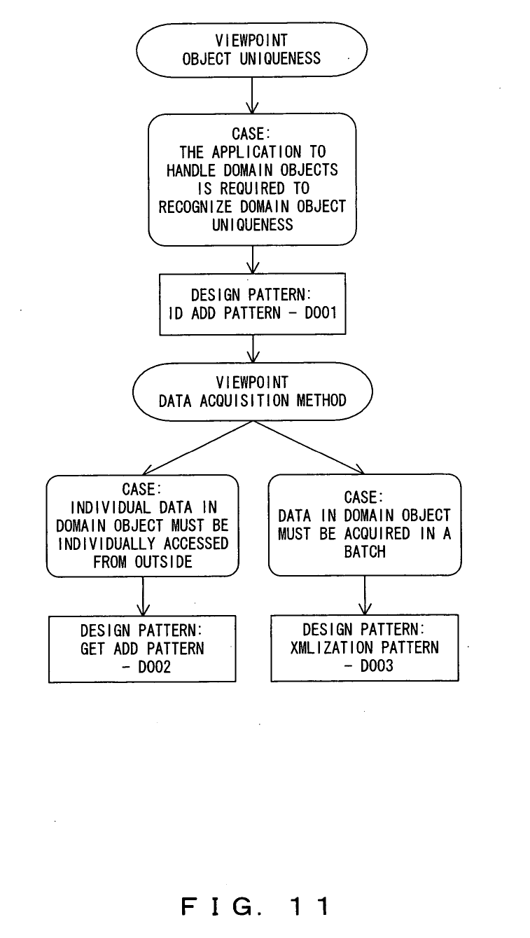

Referring to the message, the pattern developer resolves the conflict by making correction, for example, to use only either one of the two return types or to set another element for the two return values. When using only either one of the two return types for the two return values, which return type to adopt is determined depending on which one of the former pattern and the latter pattern is given priority in conflict resolution or pattern merging. In the example shown in FIG. 10, conflict resolution information to the following effect is set: Set the return value of the “get*** method” giving priority to the return value ($$Type$$) of the former pattern's “get*** method”. The prescribed priority order is also reflected in the “plural domain object storage+amount computation processing” pattern that is obtained by merging the two patterns. For example, the source code model of “tabulation (list:List):Money” of the latter pattern is corrected. The parameter $$Type$$ indicates that the return value of the method corresponds to the attribute value of the $$attrlist$$. Next, with reference to FIGS. 11 to 13, processing from order relation definition to pattern merging for another example of pattern combination will be explained.

FIG. 11 is a diagram showing an example (2) of pattern system defined via the pattern system definition unit.

The pattern system shown in FIG. 11 corresponds to “Viewpoint: Object uniqueness determination”. In the pattern system, two order relations are defined between design patterns. One of them is defined between “ID add pattern-D001” and “get add pattern-D002” and the other is defined between“ID add pattern-D001” and“XMLization pattern-D003”.

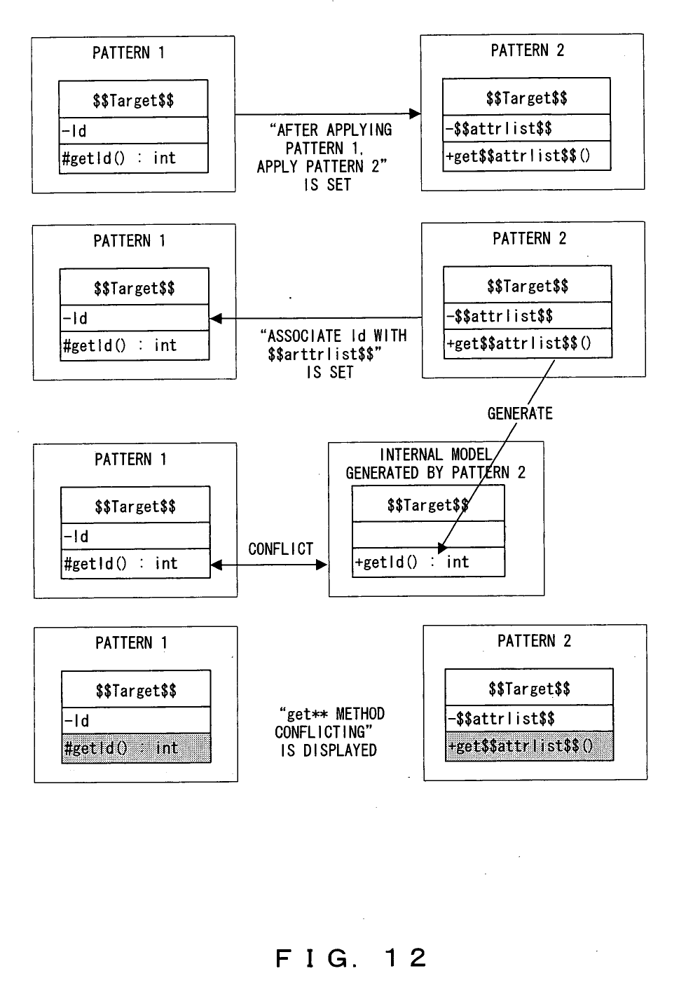

FIG. 12 is a diagram for explaining more concretely one of the inter-pattern order relations defined in FIG. 11.

In FIG. 12, the pattern 1 corresponds to “ID add pattern-D001” shown in FIG. 11 and the pattern 2 corresponds to “get add pattern-D002” also shown in FIG. 11.

In FIG. 12, each character string prefixed and postfixed with “$$” represents a parameter. When being applied (added) to the model, the parameters, as normally done, set, for example, a model name, a model attribute and a method corresponding to the model.

For example, the “$$Target$$” is a parameter to set the name of a model to which the pattern is to be applied. The “$$attrlist$$ is a parameter capable of setting all attributes of the model to which the pattern is to be applied. Also in FIG. 12, the string “#getid( ):int” indicates that the scope (visibility) of the method named getid is “# (protected)” and that the return value of the method is “int(integer type)”.

In the first tier of FIG. 12, it is shown that an order relation “After applying pattern 1, apply pattern 2” has been set for the patterns 1 and 2 by the pattern developer.

In the second tier of FIG. 12, it is shown that mapping information “Associate “Id” with “$$attrlist$$”” has been set by the pattern developer.

Consequently, as shown in the third tier of FIG. 12, as a method with a name of “get+attribute” to be generated by the pattern 2, a method named “getid” is generated, but a method having the same name also exists in the pattern 1. Since the two methods have different scopes, that is, “# (protected)” in the pattern 1 and “+(public)” in the pattern 2, the methods named “getId” are determined to be conflicting elements. The conflicting elements are highlighted on the display as shown in the fourth tier of FIG. 12.

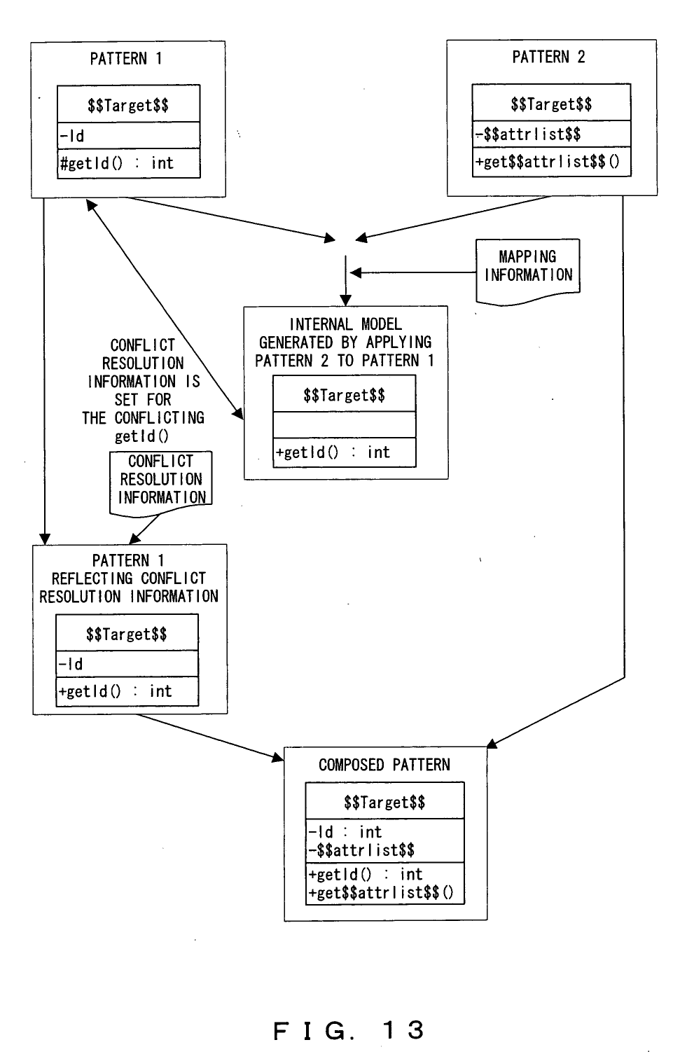

FIG. 13 is a diagram for explaining merging of the patterns 1 and 2 shown in FIG. 12.

In FIG. 13, as in FIG. 12, it is shown that an order relation “After applying pattern 1, apply pattern 2” is set by the pattern developer and that mapping information “Associate “Id” with “$$attrlist$$”” is also set by the pattern developer. As a result, a conflict occurs between the “getId” methods as described above. The conflict is, however, resolved as the conflict resolution information giving priority to the pattern 2, namely, “Set the scope of the getid method of the pattern 1 to “+(public)”” is set by the pattern developer.

In accordance with the inter-pattern priority order, the conflicting portion of the pattern 1 is corrected and the patterns 1 and 2 reflecting the conflict resolution information are merged into a single pattern (a composite pattern).

The pattern generated by merging is stored as a single merged pattern in the pattern information storage unit 55. The pattern system which partly uses the merged pattern is, as required, also inputted (created) by the pattern developer via the pattern system definition unit 52 and stored in the inter-pattern association information storage unit 56.

Next, reverting to FIG. 4, the pattern application apparatus will be explained.

The pattern application apparatus shown in FIG. 4 includes the pattern information storage unit 55, the inter-pattern association information storage unit 56, a pattern system navigation unit 59, a pattern application unit 58, and an applicability determination unit 57. The pattern application apparatus is used by a general developer engaged in-object-oriented software development when he or she applies a pattern to a model to be developed in the course of software development work.

The precondition for pattern application mentioned above that is associated with the corresponding pattern information is stored in the pattern information storage unit 55. In the inter-pattern association information storage unit 56, plural order relations, each defined for two patterns are stored. A pattern system, for example, is composed of some of the order relations stored in the inter-pattern association information storage unit 56. The mapping information and the conflict resolution information associated with some of the order relations are also stored in the inter-pattern association information storage unit 56.

The pattern system navigation unit 59 is a user interface for use by general developers. A general developer can activate the pattern application unit 58 via the pattern system navigation unit 59. The pattern system navigation unit 59 navigates a general user to a pattern to be used according to a pattern system formed based on plural inter-pattern order relations which have been defined.

The pattern application unit 58 applies patterns stored in the pattern information storage unit 55 to a model to be developed and thereby details the model. The model to be developed is stored in a model storage unit 61. The source code is stored in a source code storage unit 62.

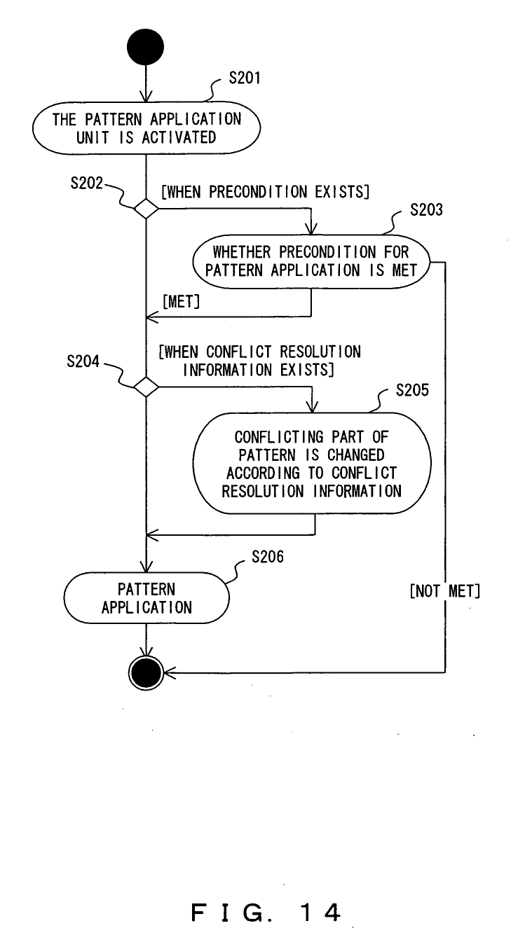

FIG. 14 is a flowchart showing processing to be performed when applying a pattern to a model to which another pattern has been applied.

In the processing shown in FIG. 14, the second pattern to be applied to the model by a general developer is indicated and, in step S201, the pattern application unit is activated based on the indicated information.

In step S202, whether or not a precondition for pattern application corresponding to the second pattern exists is determined. If such a precondition is determined to exist, the pattern applicability determination unit determines in step S203 whether or not applying the second pattern to the model meets the precondition for pattern application.

If it is determined in step S203 that the precondition for pattern application is not met, the processing is terminated. This result determines that the second pattern is not applicable to the model. If it is determined in step S203 that the precondition for pattern application is met, the processing advances to step S204 in which whether or not the association information (order relation) for the second pattern and the previously applied pattern includes conflict resolution information is determined. If the conflict resolution information is determined to exist, the processing advances to step S205 in which the conflicting portion of the second pattern is corrected. The processing then advances to step S206.

The processing advances to step S206 also when the conflict resolution information is determined not to exist in step S204. In step S206, the second pattern is applied to the model causing the model to be detailed.

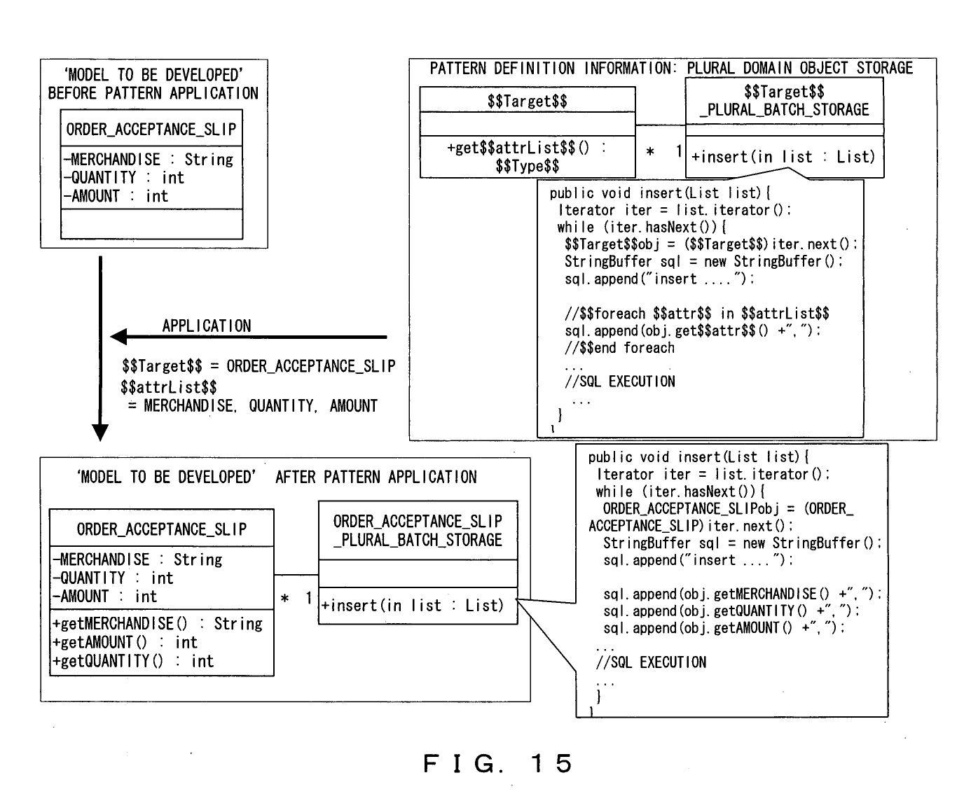

FIGS. 15 to 17 are diagrams, each for explaining a case in which a design pattern shown in FIG. 6 is applied. When, of two patterns which belong to a same category and an order relation between which has been defined, the higher-order (i.e., preceding or former) pattern is specified for a general user, the pattern system navigation unit 59 proceeds to navigate the general user to the corresponding lower-order (i.e., next or latter) pattern.

FIG. 15 is a diagram for explaining a case in which a first pattern is applied to a model to be developed.

In the processing shown in FIG. 15, the model to be developed is acquired from the model storage unit and one of the patterns stored in the pattern information storage unit, that is in this example, the “plural domain object storage” pattern (hereinafter referred to as the “former” pattern) corresponding to the design pattern D001 shown in FIG. 6 is applied to the model. When the former pattern is applied to the model to be developed, data are obtained from plural domain objects and a class and a method for storing the data in an RDB are added to the model to be developed. In FIG. 15, the “$$Target$$_PLURAL_BATCH_STORAGE” class and the “insert( )” method correspond to the above-mentioned class and method, respectively. The source code corresponding to the “insert( )” method is also shown in FIG. 15.

When a general developer applies the former pattern, the general developer makes the following settings for $$Target$$ and $$attrList$$, which are parameters of the former pattern, on the input screen displayed by the pattern system navigation unit:
   $$Target$$=ORDER_ACCEPTANCE_SLIP
   $$attrList$$=MERCHANDISE, QUANTITY, AMOUNT

The former pattern is applied to the model to be developed in accordance with the above settings and, as shown in the lower left part of FIG. 15, the ORDER_ACCEPTANCE_SLIP_PLURAL_BATCH_STORAGE class and the “insert( )” method belonging to the class are added to the model to be developed. In the “insert( )” method, changes are made to the corresponding source code to reflect the above settings.

FIG. 16 is a diagram for explaining a case in which a second pattern is applied to a model to be developed to which the first pattern shown in FIG. 15 has been applied.

As shown in FIG. 16, a first pattern has been applied, in the manner described with reference to FIG. 15, to the model to be developed that has been obtained from the model storage unit. The pattern system navigation unit applies, as a second pattern, the “tabulation” pattern (hereinafter referred to as the “latter pattern”) that corresponds to the design pattern D003 shown in FIG. 6 to the model to which the first pattern has been applied based on the pattern system shown in FIG. 6.

When the latter pattern is applied to the model to be developed, data obtainable by an arbitrary method are obtained from plural domain objects and a class and a method for totalizing the obtained data are added to the model to be developed. In FIG. 16, the “$$Target$$_TABULATION” class and the “Tabulation( )” method correspond to the above-mentioned class and method, respectively. The source code corresponding to the “tabulation( )” method is also shown in FIG. 16.

When a general developer applies the latter pattern, the general developer makes the following settings for $$Target$$ and $$operation$$, which are parameters of the latter pattern, on the input screen displayed by the pattern system navigation unit:
   $$Target$$=ORDER_ACCEPTANCE_SLIP
   $$operation$$=getAMOUNT ( )

In accordance with the above settings, the latter pattern is applied to the model to be developed and, as shown in the lower left part of FIG. 16, the order acceptance slip tabulation class and the “Tabulation( )” method belonging to the class are added to the model to be developed. In the “Tabulation( )” method, changes are made to the corresponding source code to reflect the above settings.

FIG. 17 is a diagram for explaining a case in which a pattern is applied to another model to be developed.

In the processing shown in FIG. 17, a model to be developed, to which no pattern has been applied, is obtained from the model storage unit and one of the patterns stored in the pattern information storage unit, that is in this example, the “single domain object storage” pattern corresponding to the design pattern D002 shown in FIG. 6 is applied to the model. When the pattern is applied to the model to be developed, data is obtained from a single domain object and a class and a method for storing the data in an RDB are added to the model to be developed. In FIG. 17, the “$$Target$$_SINGULAR_STORAGE” class and the “insert2( )” method correspond to the above-mentioned class and method, respectively. The source code corresponding to the “insert2( )” method is also shown in FIG. 17.

When a general developer applies the pattern, the general developer makes the following settings for $$Target$$ and $$attrList$$, which are parameters of the pattern, on the input screen displayed by the pattern system navigation unit:
   $$Target$$=ORDER_ACCEPTANCE_PACKAGE_SLIP
   $$attrList$$=MERCHANDISE, QUANTITY, AMOUNT

In accordance with the above settings, the “single domain object storage” pattern is applied to the model to be developed and, as shown in the lower left part of FIG. 17, the order acceptance package slip singular storage class is added to the model to be developed and the “insert2( )” method for storing data into an RDB is added to the class. In the “insert2( )” method, changes are made to the corresponding source code to reflect the above settings.

As shown in FIG. 17, the “get***” method added to the order acceptance package slip (model) has an argument which is a number specifying that the number-th data in the array corresponding to the attribute indicated by “***” is to be obtained. Furthermore, an attribute representing the number of items in the array (indicated as “number of items” in FIG. 17) and the “get NUMBER_OF_ITEMS( )” method for obtaining the number of items are added to the order acceptance package slip (model).

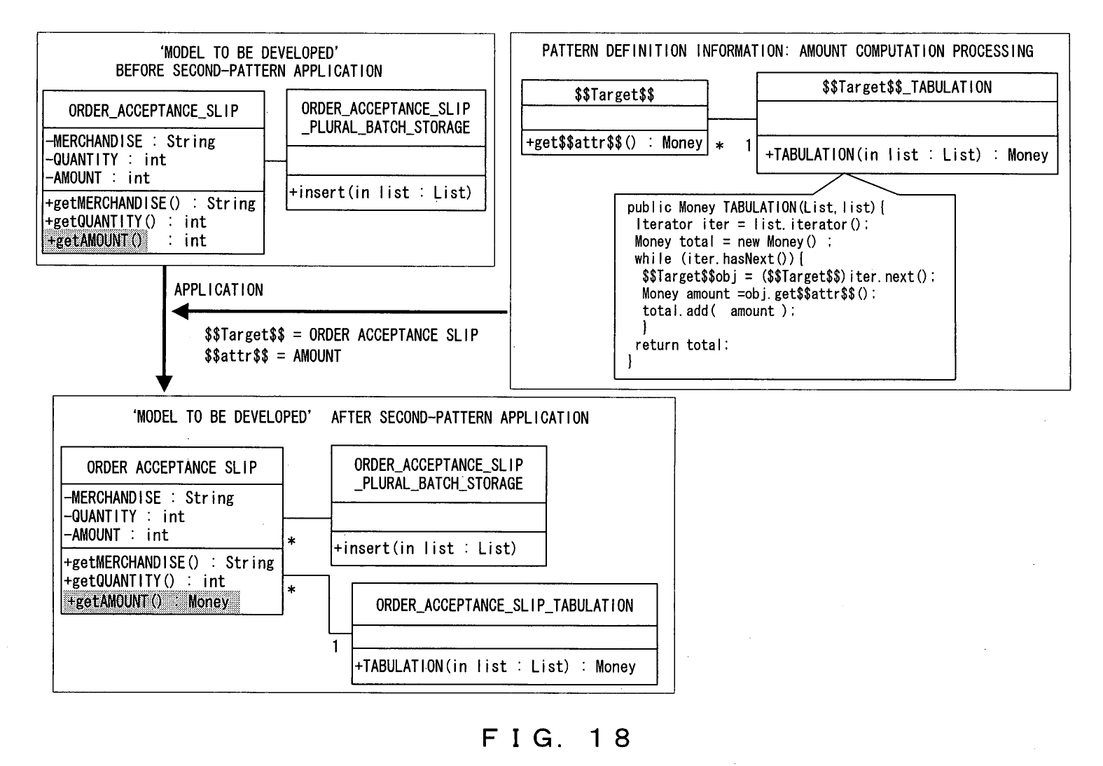

FIG. 18 is a diagram for explaining a case in which a second pattern different from the second pattern shown in FIG. 16 is applied to a model to be developed to which the first pattern shown in FIG. 15 has been applied.

As shown in FIG. 18, a first pattern has been applied, in the manner described with reference to FIG. 15, to the model to be developed that has been obtained from the model storage unit. As shown in the right-hand part of FIG. 18, a second pattern different from the second pattern shown in FIG. 16 is applied to the model to which the first pattern has been applied. As a result, in the model to which the second pattern has been applied, the return value of the “get amounts” method becomes of the “Money” type.

When the second pattern has not been applied to the model to which the first pattern has been applied, the return value of the “get amount( )” method in the model has been of the “int” type. Applying the second pattern to the model in that state generates a conflict in the return value of the “get amount( )” method.

Conventionally, for example, according to the technique disclosed in the above patent document 3, a general developer is required to determine whether or not a conflict as described above occurs. Even after detecting and resolving a conflict, the general developer is required, in the course of detailing the model, to rewrite the source code corresponding to the model as required, for example, based on the priority order between the former and the latter patterns.

In the present embodiment of the invention, there are cases in which, when a conflict occurs between patterns, the corresponding conflict resolution information as described above is stored, being associated with the order relation between the conflicting patterns, in the pattern information storage unit in the stage of pattern development. In such cases, the conflict resolution information is automatically reflected in the pattern application when the pattern application unit applies a second pattern to the model to be developed. Therefore, the pattern application can be carried out efficiently.

In a case in which two patterns have been merged by the pattern merging unit based on an order relation defined for them, information to that effect is given to a general developer when the pattern application unit applies a first pattern to the model to be developed. In such a case, the corresponding source code model was already corrected, at the time when the two patterns were merged, based on the priority order defined for the patterns so that the general developer need not perform such correction.

Suppose, for example, the design patterns D001 and D003 shown in FIG. 3 have been merged. In such a case, when the design pattern D002 is applied to the model to be developed, the pattern system navigation unit displays a message reading, for example, “A pattern generated by merging D001 and D003 exists” for the general developer. If the general developer having been given such information wishes to continue using the patterns D001 and D003, the general developer can issue an instruction to “use the merged pattern” via the pattern system navigation unit. The general developer can then proceed efficiently with pattern application, unlike when applying the individual patterns, without being required to correct the source code.

In the case shown in FIG. 6, the pattern D003 is the only option (case) available in responding to the viewpoint provided immediately after the pattern D001. Hence, when the pattern D001 is applied, information like “A pattern generated by merging the patterns D001 and D003 exists” is displayed. If there are plural options available, i.e., if there are, for example, two options available in responding to the viewpoint provided immediately after the pattern D001, a list of the corresponding merged patterns is displayed. The general developer, if to use a merged pattern, selects one of the listed merged patterns or, if not to use any merged pattern, issues an instruction not to use any merged pattern via the pattern system navigation unit.

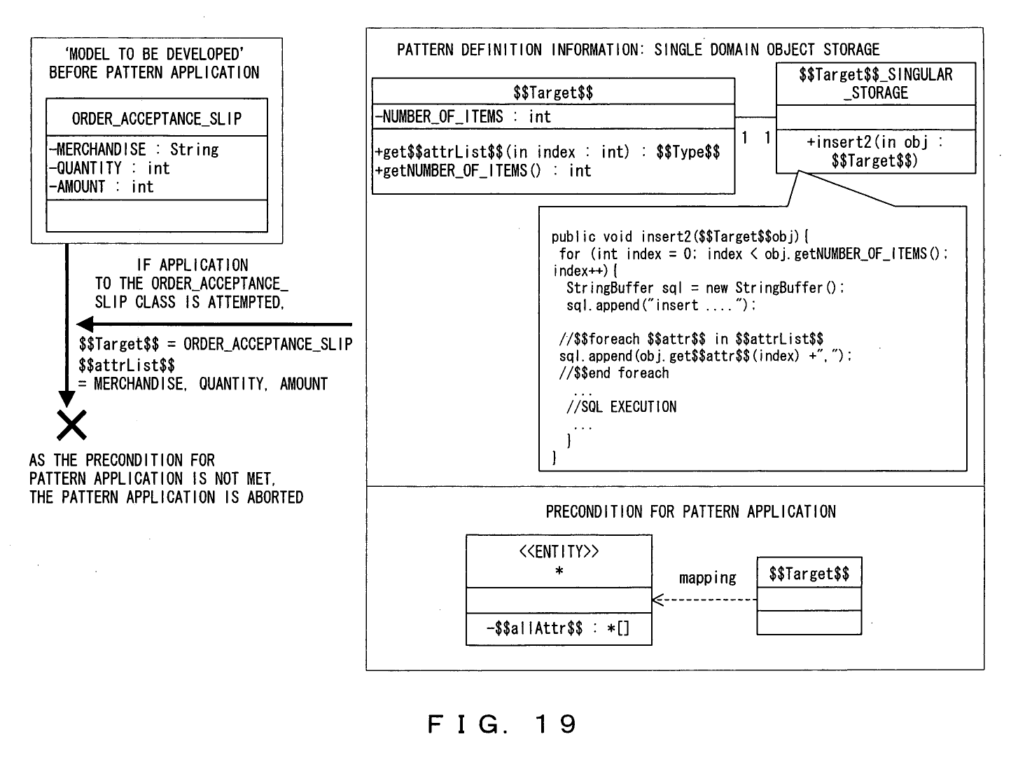

FIG. 19 is a diagram for explaining a case in which an error in pattern application is avoided using a precondition for pattern application.

As shown in FIG. 19, when an attempt is made to apply the “single domain object storage” pattern to a model to be developed, the applicability determination unit refers to the precondition for pattern application stored, being associated with the pattern, in the pattern information storage unit to determine whether or not applying the pattern to the model to be developed meets the precondition for pattern application. According to FIG. 19, the model (class) to which the pattern is to be applied is required to have a stereotype “entity” and all attributes of the model (class) are required to be arrayed. In this way, erroneous pattern application by a general developer, for example, on account of inadequate understanding of the operation to be performed can be avoided.

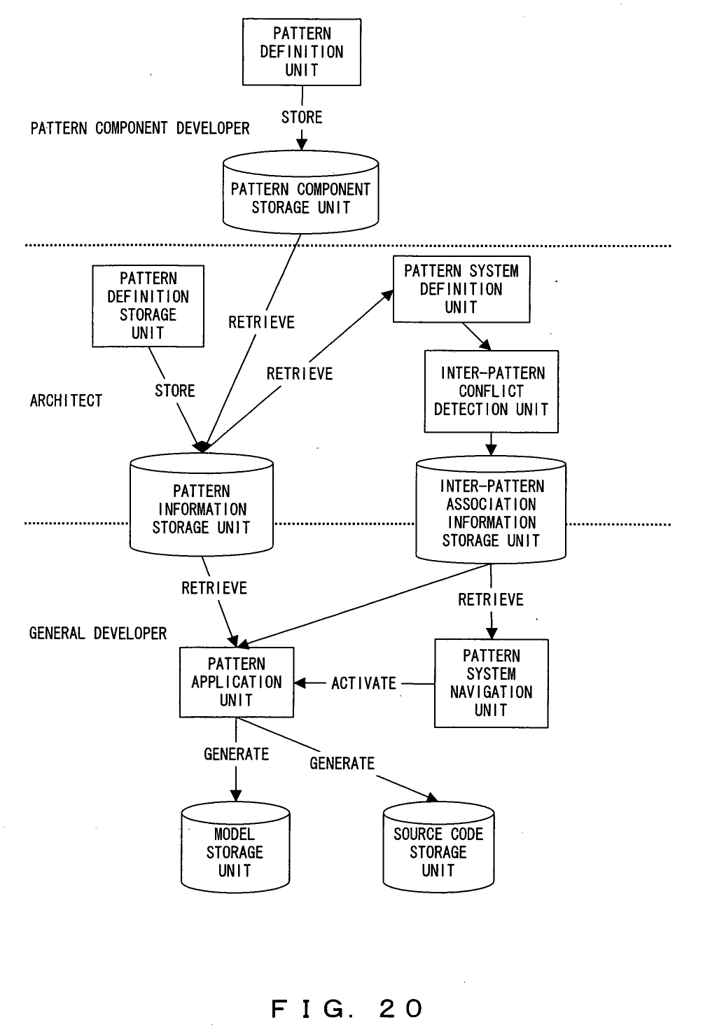

FIG. 20 is a diagram (1) for explaining work distribution to developers in using an object-oriented software development support apparatus according to the present invention or an object-oriented software development support apparatus incorporating a pattern system generation apparatus according to the present invention.

In FIG. 20, what is referred to as the “pattern developer” in the above is divided into the “pattern component developer” and the “architect”. The “pattern component developer” is specialized in developing pattern components based on which conflict detection processing is performed. The “architect” develops pattern components and defines an order relation between two patterns specified out of the developed pattern components. When the two patterns are specified, the inter-pattern conflict detection unit is activated and the conflict detection processing is performed. As a result of the conflict detection processing, for example, the conflict resolution information is stored in the inter-pattern association information storage unit.

The “general developer” sequentially applies patterns to a model to be developed via the pattern system navigation unit. When the model to be developed and a pattern to be applied to the model are specified, the pattern application unit is activated in response. If, when applying a second pattern to the model to be developed, the corresponding order relation is attached with conflict resolution information, the pattern application unit reflects the conflict resolution information in the application of the second pattern to the model to be developed.

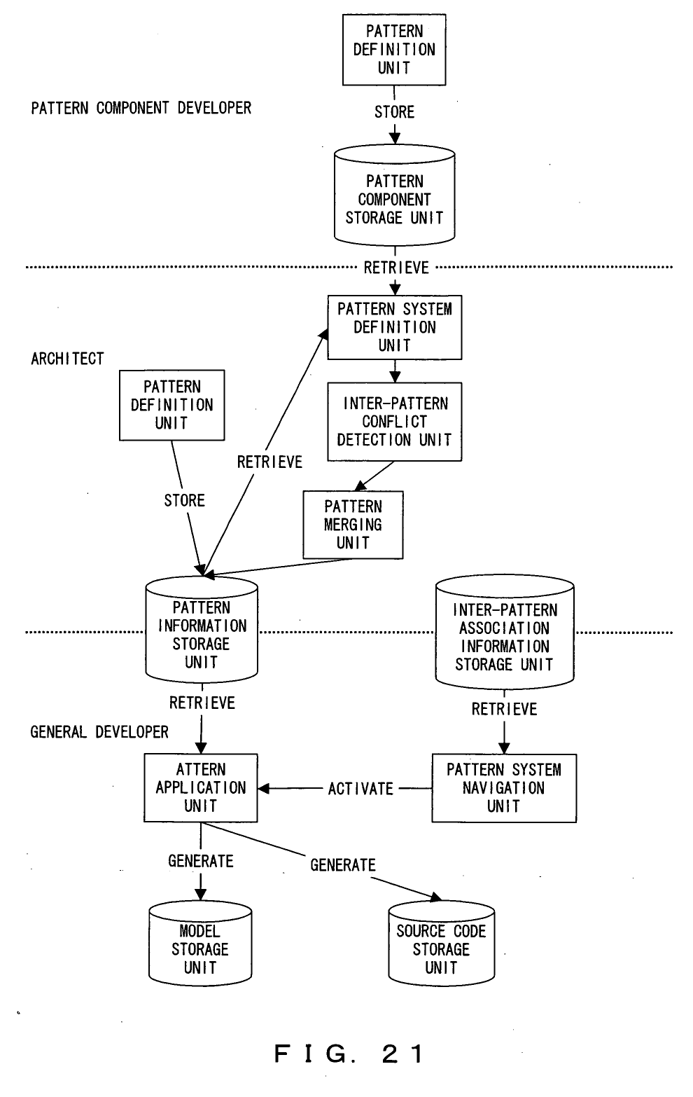

FIG. 21 is a diagram (2) for explaining work distribution to developers in using an object-oriented software development support apparatus according to the present invention or an object-oriented software development support apparatus incorporating a pattern system generation apparatus according to the present invention.

The description of FIG. 21 here will center on its differences from FIG. 20. The pattern merging unit shown in FIG. 21 is not shown in FIG. 20. As regards the work distribution, merging of patterns (for which order relations have been defined) performed using the pattern merging unit is undertaken by the “architect”.

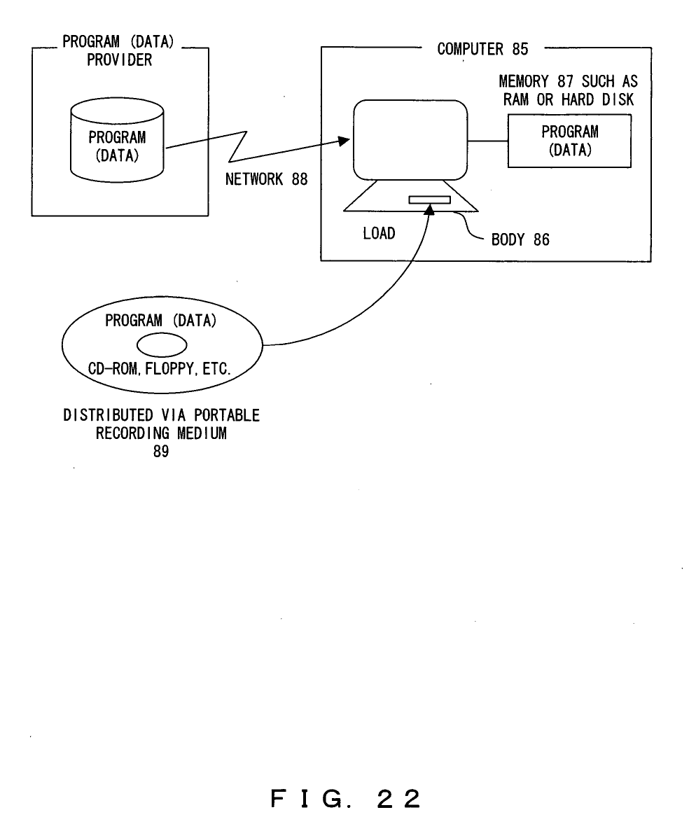

FIG. 22 is a diagram for explaining loading of a program.

As shown in FIG. 22, a software development support apparatus according to the present invention is obviously feasible using a general computer system. Such a computer 85 is basically composed of a body 86 and a memory 87. For execution, a program to perform the processing of the present invention may be loaded into the memory 87 from a portable storage medium 89 or the program may be loaded into the memory 87 from a program provider side via a network 88.

The foregoing invention has been described in terms of preferred embodiments. However, those skilled, in the art will recognize that many variations of such embodiments exist. Such variations are intended to be within the scope of the present invention and the appended claims.

1. A pattern system generation apparatus comprising:
a pattern information storage unit for storing plural patterns usable for object-oriented software development;
a pattern system definition unit capable of defining order relations, each between two of the plural patterns;
an inter-pattern association information storage unit for storing order relations, each defined for two of the plural patterns; and
an inter-pattern conflict detection unit for detecting conflicting elements in the defined order relations;
wherein the pattern system definition unit is capable of activating the inter-pattern conflict detection unit.

2. The pattern system generation apparatus according to claim 1, wherein:
the pattern system definition unit is capable of defining mapping information which indicates that a model element generated by a pattern applied first is used as a parameter of a pattern to be applied next and storing the defined mapping information in the inter-pattern association information storage unit, the defined mapping information stored being associated with the order relations; and
the inter-pattern conflict detection unit detects conflicts taking into account the mapping information.

3. The pattern system generation apparatus according to claim 1, wherein the pattern system definition unit is capable of specifying conflict resolution information for resolvable conflicting elements and storing the specified conflict resolution information in the inter-pattern association information storage unit, the specified conflict resolution information stored being associated with the order relations.

4. The pattern system generation apparatus according to claim 1, further comprising a pattern merging unit capable of merging two patterns for which an order relation has been defined.

5. A pattern application apparatus comprising:
a pattern information storage unit for storing plural patterns usable for object-oriented software development,
an inter-pattern association information storage unit capable of storing plural order relations, each defined for two of the plural patterns, and conflict resolution information specified for resolvable conflicting elements in the order relations, the specified conflict resolution information stored being associated with the order relations,
a pattern application unit for detailing a model to be developed by applying a pattern stored in the pattern information storage unit to the model, and
a pattern system navigation unit capable of activating the pattern application unit by specifying the model to be developed and a pattern.

6. The pattern application apparatus according to claim 5, wherein;
the pattern application unit comprises a determination unit for determining, when applying two patterns to the model to be developed, whether or not conflict resolution information corresponding to the two patterns exists and, in a case wherein the conflict resolution information is determined to exist, performs the pattern application reflecting the conflict resolution information.

7. The pattern application apparatus according to claim 5, wherein;
the pattern information storage unit further stores preconditions for pattern application each of which indicates a precondition for applying a pattern, the preconditions for pattern application stored being associated with the patterns, and
the pattern application apparatus further comprises an applicability determination unit for determining, when applying the pattern to the model to be developed, whether or not the pattern is applicable based on the precondition for pattern applicability.

8. The pattern application apparatus according to claim 5, wherein:
the inter-pattern association information storage unit stores information on patterns each obtained by merging two patterns for which an order relation has been defined, the information on the patterns stored being associated with the order relations, and
the pattern system navigation unit, when applying two patterns to the model to be developed, determines whether or not a merged pattern corresponding to the two patterns exists in the pattern information storage unit and, if the merged pattern exists, indicates information to a user urging the user to determine whether or not to apply the merged pattern to the model to be developed.

9. The pattern application apparatus according to claim 8, wherein:
the pattern system navigation unit performs navigation based on a pattern system generated from one or more order relations stored in the inter-pattern association information storage unit;
when a pattern of a higher-order in the order relations is specified, the pattern system navigation unit determines, for each of the order relations composed of the higher-order pattern and one or more corresponding lower-order patterns, whether or not a merged pattern exists being stored in the pattern information storage unit; and,
if one or more merged patterns exist, the pattern system navigation unit indicates information to the user urging the user to determine whether to apply one of the corresponding one or more merged patterns to the model to be developed or to apply none of the merged patterns to the model to be developed.

10. An object-oriented software development support apparatus comprising:
a pattern information storage unit for storing plural patterns usable for object-oriented software development,
a pattern system definition unit capable of defining an order relation between two of the plural patterns,
an inter-pattern association information storage unit for storing an order relation defined for two of the plural patterns, and
an inter-pattern conflict detection unit for detecting a conflicting element in the defined order relation, wherein;
the pattern definition unit is capable of activating the inter-pattern conflict detection unit, specifying conflict resolution information for a resolvable conflicting element and storing the specified conflict resolution information in the inter-pattern association information storage unit, the specified conflict resolution information stored being associated with the order relation, and
the object-oriented software development support apparatus further comprises a pattern application unit for detailing the model to be developed by applying a pattern stored in the pattern information storage unit to the model to be developed and a pattern system navigation unit capable of activating the pattern application unit by specifying the model to be developed and a pattern.

11. A storage medium for storing a program which makes a computer perform processing to detect conflicts between patterns to support object-oriented software development, wherein the program makes the computer perform processing to detect a conflicting element between two patterns, for which an order relation has been defined, out of plural patterns stored in a storage means of the computer.

12. A storage medium for storing a program which makes a computer perform processing to apply patterns to a model to be developed to support object-oriented software development, wherein;
the program, when applying two patterns to the model to be developed, makes the computer perform processing to determine whether or not conflict resolution information corresponding to the two patterns being applied exists and,
the program, in a case in which the conflict resolution information is determined to exist, makes the computer perform processing to apply the patterns reflecting the conflict resolution information.

13. A storage medium for storing a program which makes a computer perform navigation processing in applying a pattern to a model to be developed to support object-oriented software development, wherein;
the program makes the computer perform processing to generate a pattern system based on one or more order relations stored in a storage means of the computer,
when a pattern of a higher-order in the order relations is specified, the program makes the computer perform processing to determine, for each of the order relations composed of the higher-order pattern and one or more corresponding lower-order patterns, whether or not a merged pattern exists being stored in the storage means of the computer and,
if one or more merged patterns exist, the program makes the computer perform processing to display, on a display means of the computer, information urging a user to determine whether to apply one of the corresponding one or more merged patterns to the model to be developed or to apply none of the merged patterns to the model to be developed.

14. A storage medium for storing a program which supports object-oriented software development, wherein; the program makes a computer perform processing to detect a conflicting element in two patterns, for which an order relation has been defined, out of plural patterns,
the program makes a computer perform processing to store conflict resolution information for the conflicting element, and,
when applying two patterns to a model to be developed whereas the conflict resolution information exists, the program makes the computer perform processing to apply the patterns reflecting the conflict resolution information.
